(19) United States
(12) Patent Application Publication
(10) Pub. No.: US 2015/0173087 A1
(43) Pub. Date: Jun. 18, 2015

(54) METHOD AND APPARATUS FOR COMMUNICATION WITH COORDINATION OF MODULATION SCHEMES AMONG BASE STATIONS FOR IMPROVED INTERFERENCE CANCELLATION

(71) Applicant: BROADCOM CORPORATION, Irvine, CA (US)

(72) Inventors: Karl Marko Juhani Lampinen, Oulu (FI); Tommi Koivisto, Espoo (FI); Mihai Horatiu Enescu, Espoo (FI); Timo Eric Roman, Espoo (FI); Maja Loncar, Frederiksberg (DK); Lars Christensen, Charlottenlund (DK); Soeren Skovgaard Christensen, Dyssegard (DK)

(73) Assignee: BROADCOM CORPORATION, Irvine, CA (US)

(21) Appl. No.: 14/404,563

(22) PCT Filed: May 30, 2013
(86) PCT No.: PCT/IB13/54472

§ 371 Date: Nov. 28, 2014

(30) Foreign Application Priority Data
May 31, 2012 (GB) 1209741.6

(51) Int. Cl. H04W 72/08

(52) U.S. Cl. CPC H04W 72/082

(57) ABSTRACT

A method, apparatus and computer program product are provided to suppress interference, such as interference attributable to increased network density, interference attributable to interference between uplink and downlink transmissions in a TDD system and/or interference attributable to D2D communications. In the context of a method, it is determined whether communication between an access point and a mobile terminal or between a mobile terminal and another mobile terminal is to be subjected to real-valued modulation or complex-valued modulation such that the modulation and a dominant form of interference for the mobile terminal are either both real-valued or both complex-valued. The method also includes providing for communication with the mobile terminal in accordance with the one of real-valued modulation or complex-valued modulation that was determined.

### TECHNICAL FIELD

An example embodiment of the present invention relates generally to communications technology and, more particularly, to interference suppression.

### BACKGROUND

As communication with mobile terminals increases, network operators endeavour to improve the utilization of their spectrum. One technique for improving the utilization of their spectrum is to increase the network density, such as by more densely deploying the network with smaller cells. In some examples, increasing the network density through the addition of macro sites or smaller cells, such as in the context of heterogeneous network deployments, may lead to increased interference conditions and thus may result in the degradation of the quality of service.

Another technique for improving the spectrum efficiency in time domain duplex (TDD) systems is to enable more dynamic selection of the switching point between downlink and uplink transmissions. As such, additional downlink allocations may be enabled in instances in which the communication with mobile terminals is downlink heavy. Another technique for increasing spectrum efficiency is to offload traffic from the network, such as by allowing mobile terminals to communicate directly with one another, such as in accordance with device-to-device (D2D) communications in a long-term evolution (LTE®) or LTE-advanced (LTE-A) network. In this instance, the mobile terminals may communicate directly with one another, thereby allowing the evolved Node B (eNB) and other network resources to utilize the spectrum for other transmissions simultaneous with the D2D communication between the mobile terminals.

However, each of these techniques for increasing the utilization of the spectrum may increase the interference. For example, in an instance in which the network density is increased, the signal quality at the receiver will become increasingly limited by interference. In addition, in an instance in which the switching point between downlink and uplink transmissions is dynamically selected in a TDD system, downlink transmissions may interfere with uplink transmissions and, conversely, uplink transmissions may interfere with downlink transmissions. Still further, in an instance in which D2D communications are supported, the D2D communication between the mobile terminals may interfere with communication between the mobile terminals and the eNBs.

A variety of techniques have been introduced in an effort to suppress interference. For example, Release 8 of the LTE® specification describes inter-cell interference coordination (ICIC) mechanisms that are primarily based upon the exchange of some interference and/or load information between the base stations over an X2 interface. Beginning with Release 10, the Third Generation Partnership Project (3GPP) has introduced enhanced ICIC (eICIC), which is intended to protect certain subframes from certain types of interference, such as the most disruptive forms of interference. In other words, eICIC is a time-domain ICIC technique that builds on the X2-based signaling of almost blank subframe (ABS) patterns among network nodes participating in the coordination.

In a heterogeneous network, macro nodes typically act as a dominant interference source for pico-nodes within their coverage. For time domain multiplexing (TDM) eICIC, the macro nodes may mute their transmissions, except for common reference signals (CRS) during one or several subframes indicated by the ABS patterns. As such, the pico-nodes may benefit from lower interference conditions and traffic offloading to the pico-nodes may be made possible, thereby increasing the overall cell throughput.

While eICIC may be applicable to a variety of interference scenarios, eICIC may not readily scale to situations in which there are multiple sources of interference since eICIC was designed essentially for a scenario in which a single source of interference was heavily interfering with another cell. eICIC also operates on a subframe level in which the protected subframes are set semi-statically since the configuration of restricted resources for mobile terminal measurements, such as radio resource management (RRM), radio link monitoring (RLM), radio resource control (RRC), etc., involve RRC signaling that may cause significant overhead if performed too frequently. While network nodes involved in eICIC may exchange ABS pattern information over the X2 interface in a dynamic fashion, the resource partitioning remains limited to the time dimension with eICIC, thereby not providing frequency domain multiplex (FDM) partitioning.

In another effort to reduce interference, Release 11 of the 3GPP specification specifies coordinated multi-point transmission/reception (CoMP), which aims at coordinating transmissions/reception between cells/access points/eNodeBs in order to reduce interference. Cells/access points/eNodeBs may also be in control of multiple transmission points under their coverage. However, Release 11 of the 3GPP specification does not contemplate coordination between access points, as there is no standardized information exchange via X2 interfaces or otherwise.

However, CoMP techniques for reducing interference require centralized control and scheduling and, as such, are not particularly applicable to situations in which the interference arises from several access points, particularly if the access points are from different network vendors. Also, CoMP techniques generally require substantial feedback of channel state information (CSI) such that CoMP techniques do not typically scale very well for denser network deployments in which more than one source of interference is to be suppressed. Furthermore, CoMP techniques are also less useful in regards to resolving interference between the uplink and downlink transmissions in a TDD system and in regards to mitigating interference arising from D2D communications.

Until the Release 10 specification, the baseline assumption, in terms of minimum performance requirements defined in RAN4 specifications, regarding the receiver of a mobile terminal was that the receiver was embodied by a simple minimum mean squared error (MMSE) receiver without co-channel interference rejection capabilities (IRC). While more advanced receivers may be implemented, such as maximum likelihood (ML) detection which can also take into account the interference structure, there have been no performance requirements for the more advanced receivers and, hence, no guarantee from a network perspective that all mobile terminals will perform well in conditions with heavy spatially coloured interference. In the Release 11 specification, however, performance requirements for MMSE-IRC receivers are being developed. In this regard, MMSE-IRC receivers are able to suppress a number of sources of interference, depending upon the number of receive antennas of the mobile terminal. For example, the most common LTE® mobile terminal includes two receive (Rx) antennas and, as such, is able to suppress one rank-1 complex-valued source of interference while receiving a rank-1 complex-valued transmission from its own cell or access point, thereby continuing to be limited in the number of sources of interference that may be suppressed. Additionally, the network must also take into account machine-type communication (MTC) devices that may be only equipped with a single receive antenna port, thereby being incapable of suppressing interference.

In receivers having, but not limited to, IRC, the use of real valued modulation may enable additional degrees of freedom for interference suppression. In this regard, real-valued signals may be received and then decoded by the receiver of a mobile terminal using an IQ split receiver, such as a widely linear receiver or non-linear receivers (e.g. maximum likelihood or serial/parallel interference cancellers), thereby enabling improved interference suppression. In an LTE® network, however, current LTE® specifications support only complex constellations, such as multiple quadrature amplitude modulation (M-QAM), such that a mobile terminal equipped with two receive antennas can efficiently mitigate interference from at most one complex-valued rank-1 source of interference so long as the desired transmission is also rank-1 complex-valued. By employing real-valued modulated transmissions, the degrees of freedom in the receiver would be increased since the intended transmission would occupy one dimension from among the four that would be available in an instance in which the receiver had two receive antennas, that is, the four dimensions defined by the two I/Q branches for each of the two receive antennas. However, the benefits of these receivers are only applicable when the signals transmitted by the mobile terminal as well as the sources of interference utilize real-valued modulation, which is challenging in regards to an LTE® network, which is configured to support complex valued modulation.

### SUMMARY

A method, apparatus and computer program product are therefore provided in accordance with an example embodiment of the present invention in order to suppress interference, such as interference attributable to increased network density, interference attributable to interference between uplink and downlink transmissions in a TDD system and/or interference attributable to D2D communications. In one embodiment, the method, apparatus and computer program product may provide for the coexistence of real-valued and complex-valued modulation while enabling improved interference suppression, such as by utilizing widely linear receivers. In this regard, the method, apparatus and computer program product of an example embodiment may coordinate the real-valued and complex-valued modulation in order to facilitate enhanced interference suppression.

According to the invention, there is provided the method of claim 1.

According to the invention, there is also provided the apparatus of claim 8.

According to the invention, there is also provided the computer program product of claim 17.

According to the invention, there is also provided the apparatus of claim 18.

According to the invention, there is also provided the method of claim 19.

According to the invention, there is also provided the apparatus of claim 26.

According to the invention, there is also provided the computer program product of claim 42.

According to the invention, there is also provided the apparatus of claim 43.

### BRIEF DESCRIPTION OF THE DRAWINGS

Having thus described some example embodiments of the invention in general terms, reference will now be made to the accompanying drawings, which are not necessarily drawn to scale, and wherein:

FIG. 1 is a schematic representation of a system that may be specifically configured in order to suppress interference in accordance with an example embodiment of the present invention;

FIG. 2 is a block diagram of an apparatus that may be embodied by either an access point or a mobile terminal and that may be specifically configured in order to suppress interference in accordance with an example embodiment of the present invention;

FIG. 3 is a flow chart of the operations performed by an apparatus embodied by an access point in accordance with an example embodiment of the present invention;

FIG. 4 is a flow chart of the operations performed by an apparatus embodied by an access point in accordance with another example embodiment of the present invention;

FIG. 5 is a flow chart of the operations performed by an apparatus embodied by an access point in accordance with a further example embodiment of the present invention; and

FIG. 6 is a block diagram of the operations performed by an apparatus embodied by a mobile terminal in accordance with an example embodiment of the present invention.

### DETAILED DESCRIPTION

The present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

As used in this application, the term “circuitry” refers to all of the following: (a) hardware-only circuit implementations (such as implementations in only analog and/or digital circuitry) and (b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions) and (c) to circuits, such as a microprocessor(s) or a portion of a microprocessor(s), that require software or firmware for operation, even if the software or firmware is not physically present.

This definition of “circuitry” applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or application specific integrated circuit for a mobile phone or a similar integrated circuit in server, a cellular network device, or other network device.

A method, apparatus and computer program product of one example embodiment of the present invention coordinate the type of modulation to be utilized such that the signals transmitted between an access point and a mobile terminal as well as the dominant form of interference have the same type of modulation, such as either real-valued modulation or complex-valued modulation. In regards to the interference, the dominant form of interference may be created by a single source of interference, e.g., a single interferer, or by two or more sources of interference, e.g., two or more interferers. For example, in regards to CoMP techniques, there may be multiple interferers brought about by transmissions between two or more mobile terminals and two or more access points. In another example, the dominant form of interference may arise within the coverage of a single access point/cell (e.g. in single-cell multi-user multiple input, multiple output (MIMO) or intra-site CoMP transmission). As another example, in regards to D2D communications, there may be multiple interferers as a result of interference created by D2D communications with a plurality of pairs of mobile terminals. As such, the mobile terminal may suppress the interference by, for example, utilizing widely linear reception. In one embodiment in which the interference is real-valued, the coordination of the type of modulation to be utilized involves an access point determining that the mobile terminal is also scheduled on physical resource blocks (PRBs) for real-valued modulation, such as pulse amplitude modulation (PAM). On the other hand, if the dominant form of interference is complex-valued, the mobile terminal may also be scheduled with complex-valued modulation. By coordinating the type of modulation for the signals transmitted between an access point and a mobile terminal with the modulation type of the interference, the mobile terminal may receive the signals and separate the in-phase (I) and quadrature (Q) branches and then perform widely linear processing of the received signal in order to suppress interference, thereby increasing the degrees of freedom for interference suppression and correspondingly improving interference rejection capabilities. For example, a mobile terminal having two receive (Rx) antennas may suppress up to three sources of interference assuming real-valued modulations are in use. In another example, a mobile terminal having one receive (Rx) antenna may suppress up to two sources of interference if these use real-valued modulations.

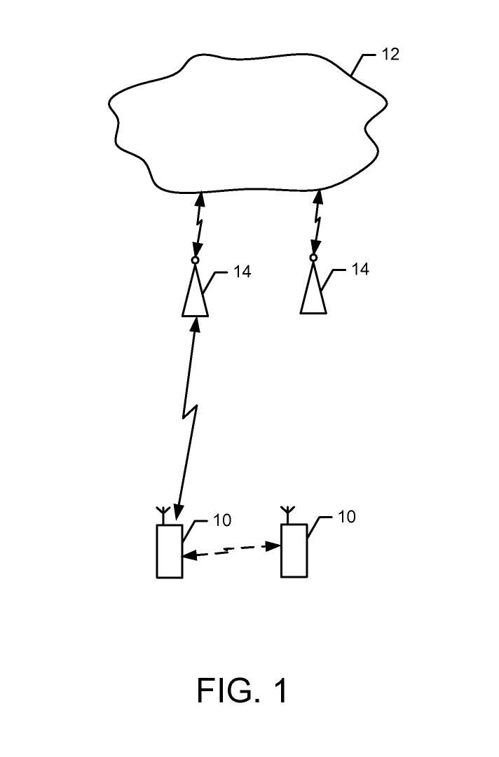

While the method, apparatus and computer program product may be utilized in conjunction with mobile terminals configured to communicate in a variety of networks, a network in which the method, apparatus and computer program product of an example embodiment may be deployed is illustrated in FIG. 1 for purposes of example, but not of limitation. As shown in FIG. 1, mobile terminals 10 may be configured to communicate with a network 12 via an access point 14, such as an evolved node B (eNB), a node B, a base station, a relay point or the like. Various types of mobile terminals (also known as user equipment (UE)) may be employed including, for example, mobile communication devices such as, for example, mobile telephones, personal digital assistants (PDAs), pagers, computers, e.g., laptop computers, tablet computers, etc., data cards, dongles, e.g., universal serial bus (USB) dongles, or any of numerous other hand held or portable communication devices, computation devices, content generation devices, content consumption devices, or combinations thereof. The access point may facilitate communication between the mobile terminals and various different types of networks including, for example, an LTE® network, an LTE-A network, a Global Systems for Mobile communications (GSM) network, a Code Division Multiple Access (CDMA) network, e.g., a Wideband CDMA (WCDMA) network, a CDMA2000 network or the like, a General Packet Radio Service (GPRS) network, an 802.11 network or other type of network.

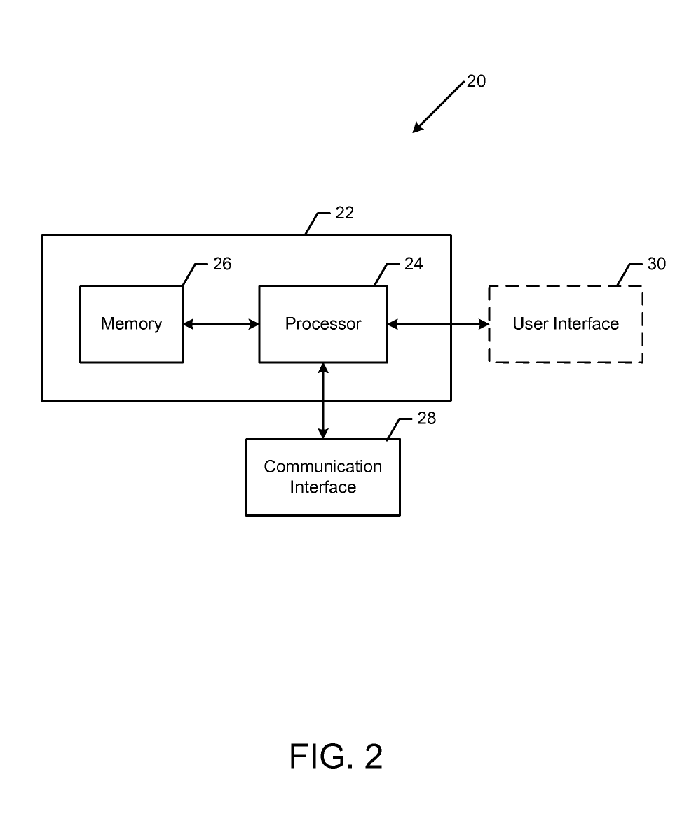

An apparatus 20 that may be embodied by or included within one or more of a mobile terminal 10, an access point 14 or other network entity is shown in FIG. 2. The apparatus may include or otherwise be in communication with a processing system including, for example, processing circuitry 22 that is configurable to perform actions in accordance with some example embodiments described herein. The processing circuitry may be configured to perform data processing, application execution and/or other processing and management services according to an example embodiment of the present invention. In some embodiments, the apparatus or the processing circuitry may be embodied as a chip or chip set. In other words, the apparatus or the processing circuitry may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus or the processing circuitry may therefore, in some cases, be configured to implement an embodiment of the present invention on a single chip or as a single “system on a chip.” As such, in some cases, a chip or chipset may constitute means for performing one or more operations for providing the functionalities described herein.

In an example embodiment, the processing circuitry 22 may include a processor 24 and memory 26 that may be in communication with or otherwise control a communication interface 28 and, at least in instances in which the apparatus 20 is embodied by a mobile terminal 10, a user interface 30. As such, the processing circuitry may be embodied as a circuit chip (e.g., an integrated circuit chip) configured (e.g., with hardware, software or a combination of hardware and software) to perform operations described herein. However, in some embodiments taken in the context of the mobile terminal, the processing circuitry may be embodied as a portion of a mobile terminal. Alternatively, in embodiments taken in the context of an access point 14 or other network entity, the processing circuitry may be embodied as a portion of the access point or other network entity.

The user interface 30 (if implemented in embodiments of the apparatus 20 embodied by a mobile terminal 10) may be in communication with the processing circuitry 22 to receive an indication of a user input at the user interface and/or to provide an audible, visual, mechanical or other output to the user. As such, the user interface may include, for example, a keyboard, a mouse, a joystick, a display, a touch screen, a microphone, a speaker, and/or other input/output mechanisms. In one embodiment, the user interface includes user interface circuitry configured to facilitate at least some functions of the mobile terminal by receiving user input via, for example, a display or touch screen, and providing output.

The communication interface 28 may include one or more interface mechanisms for enabling communication with other devices and/or networks. In some cases, the communication interface may be any means such as a device or circuitry embodied in either hardware, or a combination of hardware and software that is configured to receive and/or transmit data from/to the network and/or any other device or module in communication with the processing circuitry 22. In this regard, the communication interface may include, for example, an antenna (or multiple antennas) and supporting hardware and/or software for enabling communications with a wireless communication network and/or a communication modem or other hardware/software for supporting communication via cable, digital subscriber line (DSL), universal serial bus (USB), Ethernet or other methods.

In an example embodiment, the memory 26 may include one or more non-transitory memory devices such as, for example, volatile and/or non-volatile memory that may be either fixed or removable. The memory may be configured to store information, data, applications, instructions or the like for enabling the apparatus 20 to carry out various functions in accordance with example embodiments of the present invention. For example, the memory could be configured to buffer input data for processing by the processor 24. Additionally or alternatively, the memory could be configured to store instructions for execution by the processor. As yet another alternative, the memory may include one of a plurality of databases that may store a variety of files, contents or data sets. Among the contents of the memory, applications may be stored for execution by the processor in order to carry out the functionality associated with each respective application. In some cases, the memory may be in communication with the processor via a bus for passing information among components of the apparatus.

The processor 24 may be embodied in a number of different ways. For example, the processor may be embodied as various processing means such as one or more of a microprocessor or other processing element, a coprocessor, a controller or various other computing or processing devices including integrated circuits such as, for example, an ASIC (application specific integrated circuit), an FPGA (field programmable gate array), or the like. In an example embodiment, the processor may be configured to execute instructions stored in the memory 26 or otherwise accessible to the processor. As such, whether configured by hardware or by a combination of hardware and software, the processor may represent an entity (e.g., physically embodied in circuitry—in the form of processing circuitry) capable of performing operations according to embodiments of the present invention while configured accordingly. Thus, for example, when the processor is embodied as an ASIC, FPGA or the like, the processor may be specifically configured hardware for conducting the operations described herein. Alternatively, as another example, when the processor is embodied as an executor of software instructions, the instructions may specifically configure the processor to perform the operations described herein.

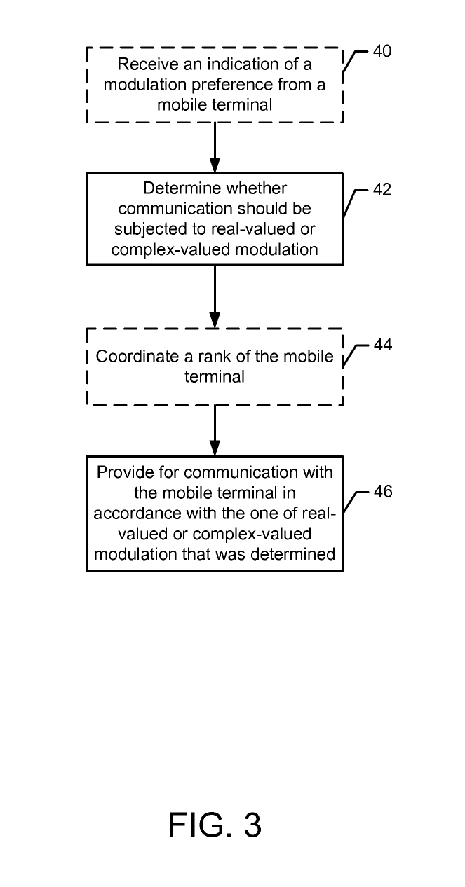

Referring now to FIG. 3, the operations performed by a method, apparatus and computer program product of an example embodiment are illustrated from the perspective of an apparatus 20 that may be embodied by or otherwise associated with a network entity, such as an access point 14. In this regard and as shown in operation 42 of FIG. 3, an apparatus embodied by an access point may include means, such as the processing circuitry 22, the processor 24 or the like, for determining whether communications should be subjected to real-valued or complex-valued modulation. The communications that is the subject of this determination will be described hereinafter in conjunction with communication between the access point and the mobile terminal 10. However, other types of communications, such as D2D communications between the mobile terminal and another mobile terminal, may alternatively be the subject of this determination in other embodiments. In this regard, the apparatus, such as the processing circuitry, the processor or the like, determines the type of modulation to be utilized for communication between the access point and the mobile terminal 10 such that the type of modulation for the communication between the access point and the mobile terminal and the dominant form of interference for the mobile terminal are either both real-valued or both complex-valued. In this regard, the dominant form of interference may arise from any of various sources of interference including, but not limited to, interference attributable to densely deployed networks, dynamic switching between uplink and downlink transmissions in a TDD system, D2D communications, coordinated transmissions and/or uncoordinated transmissions. Additionally, as noted above, the dominant form of interference may be created by one or more interferers. As described below, this determination may be made in various manners.

In one embodiment, the apparatus 20 embodied by the access point 14 may include means, such as the processing circuitry 22, the processor 24, the communication interface 28 or the like, for receiving an indication of a modulation preference from the mobile terminal 10. See block 40 of FIG. 3. This modulation preference may be determined by the mobile terminal in various manners including a determination based upon the dominant form of interference to which the mobile terminal is to be subjected with the modulation preference being selected such that it is of the same type, such as either real-valued or complex-valued, as the dominant form of interference.

The apparatus 20 embodied by the access point 14 may also include means, such as the processing circuitry 22, the processor 24, the communication interference 28 or the like, for providing for communication with the mobile terminal 10 in accordance with the one of real-valued modulation or complex-valued modulation that was determined. See block 46 of FIG. 3. In this regard, the apparatus embodied by the access point, such as the processing circuitry, the processor, the communication interface or the like, may schedule the PRBs such that a mobile terminal is scheduled with real-valued modulation, such as PAM, in an instance in which the dominant form of interference is also real-valued. Conversely, in an instance in which the interference is complex-valued, the apparatus embodied by the access point, such as the processing circuitry, the processor, the communication interface or the like, may schedule the PRBs such that the mobile terminal is scheduled with complex-valued modulation, such as QAM or M-QAM. In one embodiment, in addition to advising the mobile terminal as to the type of modulation to be utilized, the apparatus embodied by the access point may also cause an indication to be provided to the mobile terminal as to the type of feedback to be provided by the mobile terminal. For example, the type of feedback may be dependent upon the type of modulation to be utilized and, as such, may be different for real-valued modulation and for complex-valued modulation.

As shown in block 44 of FIG. 3, the apparatus 20 embodied by the access point 14 of one embodiment may also be configured to coordinate the transmission rank of the mobile terminal 10. In this regard, the apparatus embodied by the access point may include means, such as the processing circuitry 22, the processor 24 or the like, for coordinating the transmission rank of the mobile terminal. By way of example, the rank of the mobile terminal may be coordinated such that mobile terminals that are scheduled for the same type of modulation are also configured to have the same transmission rank.

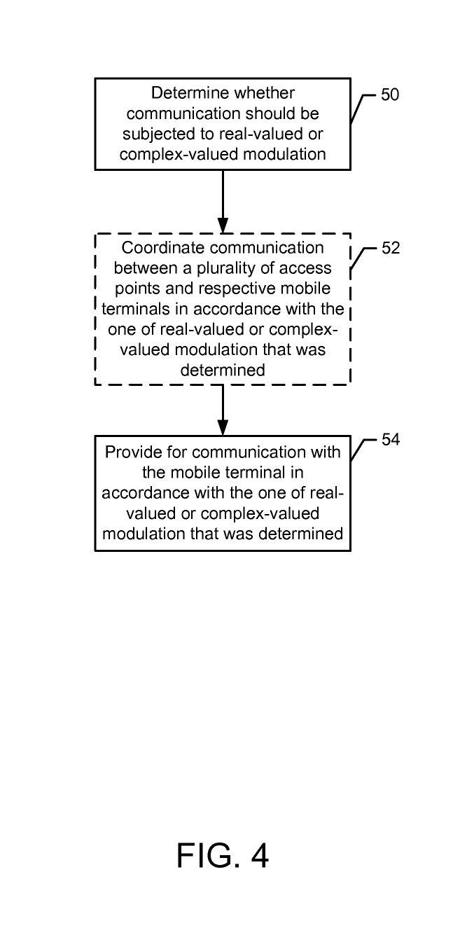

In one embodiment in which an access point 14 is configured to coordinate multi-point transmission and/or reception, an apparatus 20 embodied by the access point may determine whether communication between the access point and a mobile terminal 10 should be subjected to real-valued modulation or complex-valued modulation as shown in block 50 and as described above in conjunction with block 42 of FIG. 3. Additionally, the apparatus embodied by the access point may include means, such as the processing circuitry 22, the processor 24, the communication interface 28 or the like, for coordinating communication between a plurality of cells or access points and respective mobile terminals in accordance with the one of real-valued modulation or complex-valued modulation that was determined, such as by being subjected to the same type of modulation that was determined. See block 52 of FIG. 4. In this regard, the apparatus embodied by the access point of one embodiment may communicate with one or more cells or access points, such as via an X2 interface or fiber link, and may advise the access points of the other cells as to the type of modulation to be utilized. By coordinating the communications and, more particularly, the type of modulation to be utilized by other cells or access points, the modulation employed for communication between the access point and the mobile terminal should be of the same type as the dominant form of interference, that is, the interference from transmissions between other access points and other respective mobile terminals since all of the transmissions between the access points that are in coordination and the respective mobile terminals will be of the same type of modulation. In this regard, the apparatus embodied by the access point may also include means, such as the processing circuitry, the processor, the communication interface or the like, for providing for communication with the mobile terminal in accordance with the one of real-valued modulation or complex-valued modulation that was determined as shown in block 54 of FIG. 4 and as described above in conjunction with block 46 of FIG. 3.

Although the determination as to the type of modulation to be employed for communication between the access point 14 and the mobile terminal 10 may be accomplished in various manners, the apparatus 20 embodied by the access point of one embodiment that coordinates multi-point transmission and/or reception may include means, such as the processing circuitry 22, the processor 24, the communication interface 28 or the like, for determining whether the communication between the access point and the mobile terminal should be subjected to real-valued modulation or complex-valued modulation based upon path loss differences between the cells or access points. By way of example, if path loss differences between serving and interfering cells are small, such as below a threshold, it is likely that real valued modulation could be useful. Alternatively, if one interfering cell has significantly lower path loss than another (indicating a dominant interferer), it would be beneficial to be coordinated to use real valued modulation.

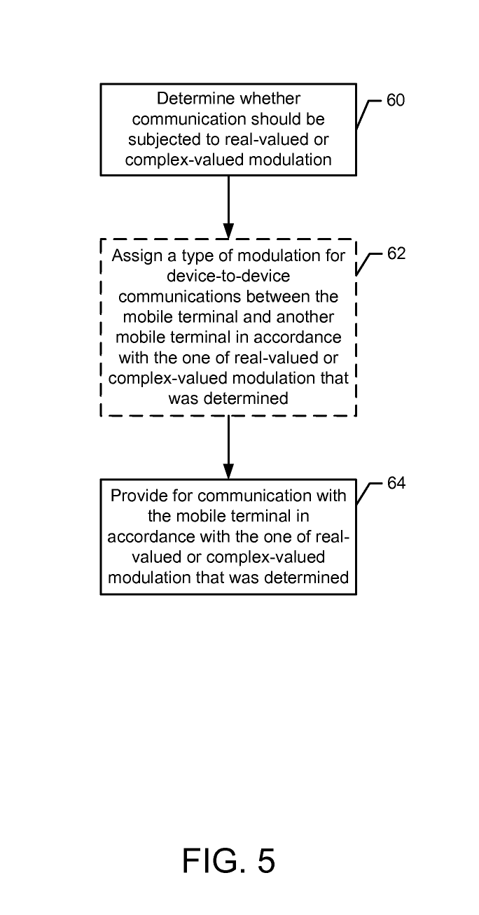

In another embodiment depicted in FIG. 5 in which the mobile terminals 10 support D2D communication, the apparatus 20 embodied by the access point 14 may again include means, such as the processing circuitry 22, the processor 24 or the like, for determining whether communication between the access point and a mobile terminal should be subjected to real-valued modulation or complex-valued modulation. See block 60 of FIG. 5. The apparatus embodied by the access point of this embodiment may also include means, such as the processing circuitry, the processor, the communication interface 28 or the like, for assigning a type of modulation for D2D communications between the mobile terminal and another mobile terminal in accordance with the one of real-valued modulation or complex-valued modulation that was determined. See block 62 of FIG. 5. In this regard, the assignment of the type of modulation for D2D communications may be done such that both the communication between the access point and the mobile terminal and the D2D communications have the same type of modulation, such as by being either both real-valued modulation or both complex-valued modulation. As such, the interference created by the D2D communications should be of the same type as the type of modulation to which the communication between the access point and the mobile terminal are subjected. The apparatus embodied by the access point of this embodiment may also include means, such as the processing circuitry, the processor, the communication interface or the like, for providing for communication with the mobile terminal in accordance with the one of real-valued modulation or complex-valued modulation that was determined as shown in block 64 of FIG. 5 and as described above in conjunction with block 46 of FIG. 3.

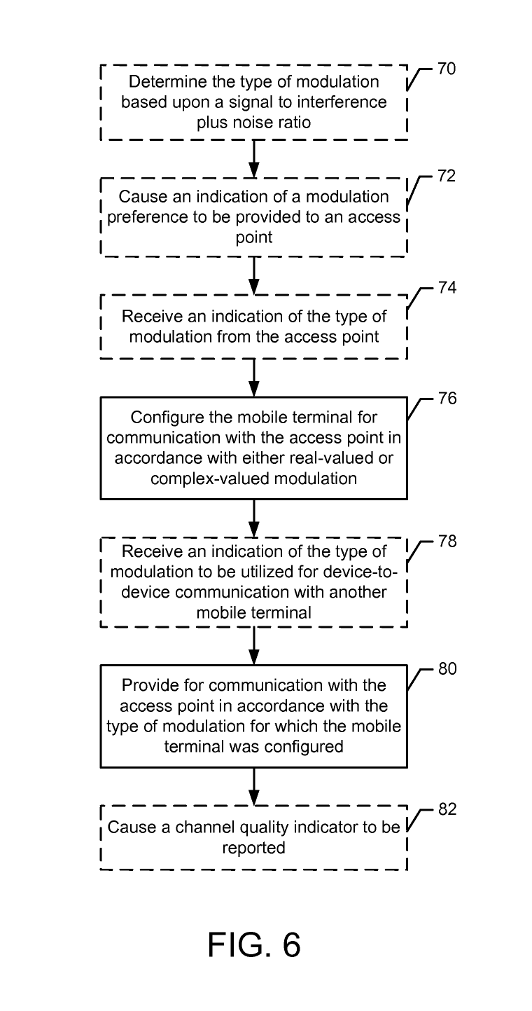

From the perspective of the mobile terminal 10, an apparatus 20 is provided that includes means, such as the processing circuitry 22, the processor 24 or the like, for configuring the mobile terminal for communication in accordance with a type of modulation selected from real-valued modulation or complex-valued modulation. See block 76 of FIG. 6. As described above in conjunction with block 42 of FIG. 3, the communications for which the mobile terminal is configured will be described hereinafter in conjunction with communication with an access point 14. However, the mobile terminal may be configured for other types of communications, such as D2D communications with another mobile terminal in other embodiments. In this regard, the type of modulation is selected such that the modulation and a dominant form of interference for the mobile terminal are either both real-valued or both complex-valued. The type of modulation may be selected and the mobile terminal may be correspondingly configured in various manners.

In one embodiment, for example, the apparatus 20 embodied by the mobile terminal 10 may include means, such as the processing circuitry 22, the processor 24, the communication interface 28 or the like, for receiving an indication of the type of modulation from the access point 14. See block 74 of FIG. 6. In this regard, the access point may have determined the type of modulation to be employed in various manners, such as described above in conjunction with FIGS. 3-5 such that the modulation employed for communication between the access point and the mobile terminal and the dominant form of interference are either both real-valued or both complex-valued. In this embodiment, the apparatus embodied by the mobile terminal, such as the processing circuitry, the processor or the like, may then configure the mobile terminal for communication with the access point in accordance with the same type of modulation as indicated by the access point.

Although the access point 14 may determine the type of modulation to be employed for communication between the access point and the mobile terminal 10 in a manner independent of input from the mobile terminal, the apparatus 20 embodied by the mobile terminal of one embodiment may include means, such as the processing circuitry 22, the processor 24, the communication interface 28 or the like, for causing an indication of a modulation preference to be provided to the access point. See block 72 of FIG. 6. In this embodiment, the access point may then take the modulation preference provided by the mobile terminal into account in its determination of the type of modulation to be employed for communication between the access point and the mobile terminal. The mobile terminal may establish a modulation preference for various reasons, but in one embodiment, may establish a modulation preference based upon the dominant form of interference that is anticipated by the mobile terminal such that both the type of modulation to be employed for communication between the access point and the mobile terminal and the dominant form of interference are the same type.

In one example, the apparatus 20 embodied by the mobile terminal 10 may include means, such as the processing circuitry 22, the processor 24, the communication interference 28 or the like, for determining the type of modulation, such as a modulation preference, based upon a signal to interference plus noise ratio (SINR). See block 70 of FIG. 6. In one example, the latter may refer to pre-processing SINR, while in another example it may refer to post-processing SINR or post-equalization SINR. In this regard, in instances in which the SINR is below a predefined threshold, the apparatus embodied by the mobile terminal may determine that real-valued modulation should be utilized for communication between the access point 14 and the mobile terminal. Conversely, in instances in which the SINR exceeds the predefined threshold, the apparatus embodied by the mobile terminal may determine that communication between the access point and the mobile terminal should be conducted in accordance with complex-valued modulation. The predefined threshold may be provided by the access point or other network entity or may be a pre-stored value, such as in memory 26 of the apparatus embodied by the mobile terminal. The modulation preference may alternatively be based on other parameters, such as the expected throughput, which can be mapped from the SINR by taking into account the spectral efficiency of the modulation and scaling by the coding rate. The apparatus 20 embodied by the mobile terminal 10 of this embodiment also includes means, such as the processing circuitry 22, the processor 24, the communication interface 28 or the like, for providing for communication with the access point 14 in accordance with the type of modulation for which the mobile terminal was configured, such as either real-valued modulation or complex-valued modulation. See block 80 of FIG. 6. As shown in block 82 of FIG. 6, the apparatus embodied by the mobile terminal may also include means, such as the processing circuitry, the processor, the communication interface or the like, for causing the channel quality indicator (CQI) to be reported to the access point. In one embodiment, the apparatus embodied by the mobile terminal, such as the processing circuitry, the processor, the communication interface or the like, may derive the CQI values corresponding to the class of real-valued modulations and may then report the derived CQI values to the access point. In another embodiment, the apparatus embodied by the mobile terminal, such as the processing circuitry, the processor, the communication interface or the like, may derive the CQI values corresponding to the class of complex-valued modulations and may then report the derived CQI values to the access point. In yet another embodiment, the apparatus embodied by the mobile terminal, such as the processing circuitry, the processor, the communication interface or the like, may derive a first class of CQI values corresponding to the class of real-valued modulations and may derive a second class of CQI values corresponding to the class of complex-valued modulations and may then report both classes of derived CQI values to the access point.

In one embodiment in which the mobile terminal 10 is also capable of D2D communications, the apparatus 20 embodied by the mobile terminal may include means, such as a processing circuitry 22, the processor 24, the communication interface 28 or the like, for receiving an indication of the type of modulation, such as real-valued modulation or complex-valued modulation, to be utilized for a device for D2D communications with another mobile terminal. See block 78 of FIG. 6. In some embodiments, the types of modulation to be utilized for the D2D communication and for communication with the access point 14 are the same, thereby facilitating both the type of modulation as utilized for communication with the access point and the dominant form of interference being of the same type of modulation.

By configuring the type of modulation to be utilized for communication between the access point 14 and the mobile terminal 10 to be of the same type as the dominant form of interference, such as interference due to densely configured networks, interference between uplink and downlink transmissions in a TDD system, interference attributable to D2D communications and/or interference attributable to coordinated or uncoordinated transmissions, the mobile terminal, such as the communication interface 28 of the mobile terminal, may mitigate interference by separating the I and Q branches and performing widely linear processing utilizing, for example, a widely linear receiver. Indeed, in one embodiment in which the mobile terminal includes at least two receiver antennas, the degrees of freedom of the receiver may be increased to four dimensions of which one is utilized for the intended transmission with the access point and the others may be utilized to suppress interference. Other type of receivers such as maximum likelihood (ML) detection can also take into account the interference structure, and therefore one is not limited to the class of linear receivers. As such, the method, apparatus and computer program product of an example embodiment may facilitate improved interference suppression, while continuing to support communications between the mobile terminal and the network, such as via an access point.

FIGS. 3-6 are flowcharts illustrating the operations performed by a method, apparatus and computer program product, such as apparatus 20 of FIG. 2, in accordance with one embodiment of the present invention. It will be understood that each block of the flowcharts, and combinations of blocks in the flowcharts, may be implemented by various means, such as hardware, firmware, processor, circuitry and/or other device associated with execution of software including one or more computer program instructions. For example, one or more of the procedures described above may be embodied by computer program instructions. In this regard, the computer program instructions which embody the procedures described above may be stored by a non-transitory memory 26 of an apparatus employing an embodiment of the present invention and executed by a processor 24 in the apparatus. As will be appreciated, any such computer program instructions may be loaded onto a computer or other programmable apparatus (e.g., hardware) to produce a machine, such that the resulting computer or other programmable apparatus provides for implementation of the functions specified in the flowchart blocks. These computer program instructions may also be stored in a non-transitory computer-readable storage memory that may direct a computer or other programmable apparatus to function in a particular manner, such that the instructions stored in the computer-readable storage memory produce an article of manufacture, the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks. As such, the operations of FIGS. 3-6, when executed, convert a computer or processing circuitry into a particular machine configured to perform an example embodiment of the present invention. Accordingly, the operations of FIGS. 3-6 define an algorithm for configuring a computer or processing circuitry, e.g., processor, to perform an example embodiment. In some cases, a general purpose computer may be provided with an instance of the processor which performs the algorithm of FIGS. 3-6 to transform the general purpose computer into a particular machine configured to perform an example embodiment.

Accordingly, blocks of the flowcharts support combinations of means for performing the specified functions and combinations of operations for performing the specified functions. It will also be understood that one or more blocks of the flowcharts, and combinations of blocks in the flowcharts, can be implemented by special purpose hardware-based computer systems which perform the specified functions, or combinations of special purpose hardware and computer instructions.

In some embodiments, certain ones of the operations above may be modified or further amplified as described below. Moreover, in some embodiments additional optional operations may also be included as shown, for example by the dashed lines in FIGS. 3-6. It should be appreciated that each of the modifications, optional additions or amplifications below may be included with the operations above either alone or in combination with any others among the features described herein. Further the operations described above and illustrated in FIGS. 3-6 may be performed in different orders in some embodiments than order that is illustrated. For example, an indication of the modulation preference may be sent after receiving an indication of the type of modulation, e.g., in case the interference affects a change in the modulation preference.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

1. A method for use by a communication device, the method comprising:
determining whether communication between an access point and a mobile terminal or between a mobile terminal and another mobile terminal is to be subjected to real-valued modulation or complex-valued modulation such that the modulation and a dominant form of interference for the mobile terminal are either both real-valued or both complex-valued; and
providing for communication with the mobile terminal in accordance with the one of real-valued modulation or complex-valued modulation that was determined.

2. A method according to claim 1 wherein the dominant form of interference is created by one or more interferers.

3. A method according to claim 1 further comprising coordinating communication between a plurality of access points and respective mobile terminals in accordance with the one of real-valued modulation or complex valued modulation that was determined.

4. A method according to claim 3 wherein determining whether communication between the access point and the mobile terminal is to be subjected to real-valued modulation or complex-valued modulation comprises determining whether communication between the access point and the mobile terminal is to be subjected to real-valued modulation or complex-valued modulation based upon path loss differences between the access points.

5. A method according to claim 1 further comprising assigning
a same type of modulation for device-to-device communications between the mobile terminal and the another mobile terminal as the one of real-valued modulation or complex-valued modulation that was determined.

6. A method according to claim 1 wherein determining whether
communication between the access point and the mobile terminal or between the mobile terminal and another mobile terminal is to be subjected to real-valued modulation or complex-valued modulation comprises receiving an indication of a modulation preference from the mobile terminal.

7. A method according to claim 1 further comprising coordinating a transmission rank of the mobile terminal such that mobile terminals served by the access point have the same transmission rank.

8. An apparatus of a communication device the apparatus comprising a processing system arranged to cause the apparatus to at least:
determine whether communication between an access point and a mobile terminal or between a mobile terminal and another mobile terminal is to be subjected to real-valued modulation or complex-valued modulation such that the modulation and a dominant form of interference for the mobile terminal are either both real-valued or both complex-valued; and
provide for communication with the mobile terminal in accordance with the one of real-valued modulation or complex-valued modulation that was determined.

9. An apparatus according to claim 8 wherein the dominant form of interference is created by one or more interferers.

10. An apparatus according to claim 8 wherein the processing system is further arranged to cause the apparatus to coordinate communication between a plurality of access points and respective mobile terminals in accordance with the one of real-valued modulation or complex-valued modulation that was determined.

11. An apparatus according to claim 10 wherein the processing system is arranged to cause the apparatus to determine whether communication between the access point and the mobile terminal is be subjected to real-valued modulation or complex-valued modulation by determining whether communication between the access point and the mobile terminal is to be subjected to real-valued modulation or complex-valued modulation based upon path loss differences between the access points.

12. An apparatus according to claim 8 wherein the processing system is further arranged to cause the apparatus to assign a same type of modulation for device-to-device communications between the mobile terminal and the another mobile terminal as the one of real-valued modulation or complex-valued modulation that was determined.

13. An apparatus according to claim 8 wherein the processing system is arranged to cause the apparatus to determine whether communication between the access point and the mobile terminal or between the mobile terminal and another mobile terminal is to be subjected to real-valued modulation or complex valued modulation by receiving an indication of a modulation preference from the mobile terminal.

14. An apparatus according to claim 8 wherein the processing system is further arranged to cause the apparatus to coordinate a transmission rank of the mobile terminal such that mobile terminals served by the access point have the same transmission rank.

15. An apparatus according to claim 8 wherein the apparatus comprises an access point.

16. An apparatus according to claim 8 wherein the apparatus is configured for use in at least one of a long term evolution or a long term evolution advanced system.

17. A non-transitory computer program product for use by a communication device, the computer-readable program instructions comprising program instructions configured, when executed by the communication device, to implement the method of claim 1.

18. An apparatus of a communication device, the apparatus comprising:
means for determining whether communication between an access point and a mobile terminal or between a mobile terminal and another mobile terminal is to be subjected to real-valued modulation or complex-valued modulation such that the modulation and a dominant form of interference for the mobile terminal are either both real-valued or both complex-valued; and
means for providing for communication with the mobile terminal in accordance with the one of real-valued modulation or complex-valued modulation that was determined.

19. A method for use by a mobile terminal, the method comprising:
configuring the mobile terminal for communication with an access point or another mobile terminal in accordance with a type of modulation selected from real-valued modulation or complex-valued modulation such that the modulation and a dominant form of interference for the mobile terminal are either both real-valued or both complex-valued; and
providing for communication with the access point or the another mobile terminal in accordance with the type of modulation.

20. A method according to claim 19 wherein the dominant form of interference is created by one or more interferers.

21. A method according to claim 19 further comprising receiving an indication of the type of modulation from the access point, wherein configuring the mobile terminal comprises configuring the mobile terminal for communication with the access point In accordance with the type of modulation indicated by the access point.

22. A method according to claim 19 further comprising determining the type of modulation based upon a signal to interference plus noise ratio.

23. A method according to claim 19 further comprising causing an indication of a modulation preference to be provided to the access point.

24. A method according to claim 19 further comprising receiving an indication of a type of modulation to be utilized for device-to-device communication with the another mobile terminal, wherein the types of modulation to be utilized for device-to-device communication and for communication with the access point are the same.

25. A method according to claim 19 further comprising causing a channel quality indicator to be reported corresponding to the type of modulation.

26. An apparatus of a mobile terminal comprising a processing system arranged to cause the apparatus to at least:
configure the mobile terminal for communication with an access point or with another mobile terminal in accordance with a type of modulation selected from real-valued modulation or complex-valued modulation such that the modulation and a dominant form of interference for the mobile terminal are either both real-valued or both complex-valued; and
provide for communication with the access point or the another mobile terminal in accordance with the type of modulation.

27. An apparatus according to claim 26 wherein the dominant form of interference is created by one or more interferers.

28. An apparatus according to claim 26 wherein the processing system is further arranged to cause the apparatus to receive an indication of the type of modulation from the access point, and wherein the processing system is arranged to cause the apparatus to configure the mobile terminal by configuring the mobile terminal for communication with the access point in accordance with the type of modulation indicated by the access point.

29. An apparatus according to claim 26 wherein the processing system is further arranged to cause the apparatus to determine the type of modulation based upon a signal to interference plus noise ratio.

30. An apparatus according to claim 26 wherein the processing system is further arranged to cause the apparatus to cause an indication of a modulation preference to be provided to the access point.

31. An apparatus according to claim 26 wherein the processing system is further arranged to cause the apparatus to receive an indication of a type of modulation to be utilized for device-to-device communication with the another mobile terminal, wherein the types of modulation to be utilized for device-to-device communication and for communication with the access point are the same.

32. An apparatus according to claim 26 wherein the processing system is further arranged to cause the apparatus to cause a channel quality indicator to be reported corresponding to the type of modulation.

33. An apparatus according to claim 26 wherein the apparatus comprises a mobile terminal.

34. An apparatus according to claim 33 further comprising user interface circuitry configured to facilitate user control of at least some functions of the mobile terminal through use of a display or a touch screen.

35. An apparatus according to claim 26 wherein the apparatus is configured for use in at least one of a long term evolution or a long term evolution advanced system.

36. A non-transitory computer program product, for use by a mobile terminal, comprising computer-readable program instructions comprising program instructions configured to, when executed by the mobile terminal, to implement the method of claim 19.

37. An apparatus of a mobile terminal, the apparatus comprising:
means for configuring a mobile terminal for communication with an access point or with another mobile terminal in accordance with a type of modulation selected from real-valued modulation or complex-valued modulation such that the modulation and a dominant form of interference for the mobile terminal are either both real-valued or both complex-valued; and
means for providing for communication with the access point or the another mobile terminal in accordance with the type of modulation.
